(19) United States
(12) Patent Application Publication
(10) Pub. No.: US 2017/0355143 A1
(43) Pub. Date: Dec. 14, 2017

(54) 3D-PRINTING METHOD AND 3D-PRINTING DEVICE

(71) Applicant: TESTIA GMBH, Bremen (DE)

(72) Inventors: Holger SPECKMANN, Schwanewede (DE); Denis KIEFEL, Munich (DE)

(21) Appl. No.: 15/615,612

(22) Filed: Jun. 6, 2017

(30) Foreign Application Priority Data
Jun. 14, 2016 (DE) 10 2016 210 542.6

(51) Int. Cl. B29C 64/386; B33Y 50/00; B29C 64/106; B33Y 10/00; B33Y 30/00

(52) U.S. Cl. CPC B29C 64/386; B33Y 10/00; B33Y 30/00; B29C 64/106; B33Y 50/00

(57) ABSTRACT

A 3D-printing method for the additive production of components includes supplying a modelling material to a 3D-printing device, determining quality characteristics of the modelling material using a monitoring device, analyzing a product quality of the modelling material, using an analysis device, on the basis of the determined quality characteristics, depositing and liquefying the modelling material layer by layer, and curing the liquefied modelling material layer by layer.

### CROSS-REFERENCE TO RELATED APPLICATION

This application claims priority to German Patent Application DE 10 2016 210 542.6 filed Jun. 14, 2016, the entire disclosure of which is incorporated by reference herein.

### TECHNICAL FIELD

The present disclosure relates to a 3D-printing method for the additive production of components and to a 3D-printing device. In particular, the present disclosure relates to monitoring the quality of supplied material during the additive production of components.

### BACKGROUND

In generative or additive production methods, also generally referred to as “3D-printing methods”, proceeding from a digitised geometric model of an object, one or more starting materials are sequentially layered one on top of the other and cured. Thus for example during selective laser melting (SLM), a component is constructed layer by layer from a modelling material, for example a plastics material or a metal, in that the modelling material is applied in powder form to a substrate and selectively liquefied by local laser radiation, resulting in a solid, continuous component after cooling. 3D-printing offers an extraordinary degree of design freedom and makes it possible, inter alia, to produce, with a reasonable amount of outlay, objects which could not be produced, or could only be produced with considerable outlay, by conventional methods. For this reason, 3D-printing methods are currently widely used in industrial design, in the automotive industry, the aerospace industry or generally in industrial product development, in which a resource-efficient process chain is used for small and large-series production, in line with demand, of customized components.

Powder residues of previously used powder materials, other foreign bodies and contaminations of the modelling material can affect the quality of components produced by additive methods. In principle, in 3D-printing methods, it is thus necessary to subject the supplied modelling material to a quality control or to otherwise ensure that the modelling material is not polluted with foreign material or other contaminations. For example, the chemical composition of a pulverulent modelling material can be analyzed on the basis of a representative sample in a laboratory environment before all of the material is used to fill a 3D-printing device; see for example the document J. A. Slotwinski et al., “Characterization of Metal Powders Used for Additive Manufacturing”, Journal of Research of the National Institute of Standards and Technology, Volume 119, 2014. If this sample meets the requirements, all of the modelling material can be approved for printing. However, should the unexamined portion of the modelling material still have defects or impurities, this is usually noticed only after the printing in the follow-up inspection of the produced component. This can make the additive production of components very time-consuming and cost-intensive, since defective components have to be separated as rejects.

### SUMMARY

In view of the above, it is an idea of the present disclosure to find simple solutions to ensure the required quality of the supplied material during the additive production.

Accordingly, a 3D-printing method for the additive production of components is provided. The 3D-printing method comprises supplying a modelling material to a 3D-printing device, determining quality characteristics of the modelling material using a monitoring device, analyzing a product quality of the modelling material, using an analysis device, on the basis of the determined quality characteristics, depositing and liquefying the modelling material layer by layer, and curing the liquefied modelling material layer by layer.

Furthermore, a 3D-printing device for the additive production of components is provided with a 3D-printing method according to the disclosure herein. The 3D-printing device comprises a monitoring device, which is configured to determine the quality characteristics of the modelling material, and an analysis device, which is configured to analyze the product quality of the modelling material on the basis of determined quality characteristics.

The concept on which the present disclosure is based relates to monitoring, “online” and in situ, the quality of the material supplied within an additive method. For this purpose, the monitoring device and/or the analysis device can be integrated directly in the 3D-printing device or coupled thereto. For example, the analysis device can comprise a microprocessor or the like, which can also carry out complex multivariate statistical analysis processes quickly and automatically. For example, the analysis device can be integrated in a central control unit of the 3D-printing device. In the present disclosure, the material, for example a powder, a granulate material, or a solid or liquid medium, can be checked whilst material is being supplied to the 3D-printing device, that is to say in principle also at the same time as the actual printing process, for foreign particles, incorrect powder, contaminations, etc. Corresponding quality defects in the modelling material can thus be detected directly in situ.

This has the considerable advantage that the actual printing process is optionally stopped, the defect is rectified and/or problematic material is removed and/or purified, and the printing process can then be continued. As a result of the present disclosure, the probability of defects occurring can be lowered, and ultimately the probability of failure of components can be reduced. Finally, the costs of detrimentally affected or insufficient quality are thus lowered.

Furthermore, the efficiency of the entire printing process can be increased to a substantial degree by early detection of defects or problems.

3D-printing methods are advantageous in particular because the methods allow the production of three-dimensional components in primary shaping methods without requiring specific manufacturing tools which are adapted to the external shape of the components. Highly efficient, material-saving and time-saving production methods for components and elements are possible as a result. Particularly advantageous are 3D-printing methods of this type for structural components in the aerospace sector since in the sector, many different components which are adapted for specific purposes are used, which can be produced in 3D-printing methods of this type at low cost, with a short production lead time and in a simple manner in the production systems required for production.

3D-printing methods within the meaning of the present application include all generative or additive production methods in which, based on geometric models, objects having a predefined shape are produced in a specific generative production system from shapeless materials such as liquids and powders or neutrally shaped semi-finished products such as strip-shaped or wire-shaped material by chemical and/or physical processes. 3D-printing methods within the meaning of the present application use additive methods in which the starting material is sequentially constructed layer by layer in predefined shapes.

According to one development, the determination of the quality characteristics and the analysis of the product quality can be carried out during the supply process. The monitoring of the modelling material can also be used to generally examine the material quality in order for example to monitor increasing degradation of a powder over multiple printing cycles. Parameter optimisations of the 3D-printing device, and thus an optimisation of the printing quality, can thus also be achieved.

According to one development, the modelling material can be supplied continuously.

According to one development, the quality characteristics of the modelling material are determined only for a portion of the supplied modelling material by random sampling. For example, depending on the volume/mass flow rate of the modelling material, all of the material or only a portion thereof can be examined. For example, when material is supplied continuously, a specific fraction of a powder can be continuously branched off and subjected to a statistical evaluation.

According to one development, the depositing and liquefying layer by layer can be stopped when the analyzed product quality does not satisfy the preset quality-conditions. For example, the printing process can be stopped when specific foreign bodies are detected in a pulverulent modelling material, or when the severity of the impurity of the powder exceeds a specific contamination threshold. For example, in a first step, a 3D-printing device can use pulverulent titanium. Should it be provided in a second step to switch from titanium to pulverulent aluminum, then undesirable titanium residues may remain in the powder supply to the 3D-printing device, which residues can diminish the desired properties of the aluminum components to be printed. As a result of the present disclosure, it is possible to locally detect and optionally eliminate such impurities before the printing process is continued.

According to one development, the modelling material can be purified when the analyzed product quality does not satisfy preset quality conditions. Therefore, not only can the printing process be stopped, for example in the case of a pulverulent modelling material being polluted with foreign bodies, but the foreign bodies and/or other impurities can also be automatically removed. In general, the modelling material can be subjected to a correspondingly necessary processing or purification, for example in which moisture is removed or the like. The printing process can then be continued using the purified modelling material. The efficiency of the disclosure herein is thus further increased in this development.

According to one development, determining the quality characteristics can include a method from the group comprising spectrometric methods, gas-sensor methods, optical methods and electrical methods or the like. A gas-sensor method can take place for example on the basis of a chemical sensor, which converts some of the modelling material into the gaseous state, for example by supplying heat, in which state the material can be quantitatively investigated (what is known as an electronic nose).

The method can be selected from the group comprising X-ray spectrometric methods, electron-spectrometric methods and infrared-spectrometric methods or the like. Possible electron-spectrometric methods are for example photoemission spectroscopy, Auger-electron spectroscopy, electron-beam microanalysis or electron energy-loss spectroscopy. X-ray spectrometric methods include X-ray absorption spectroscopy, X-ray emission spectroscopy, photoemission spectroscopy, X-ray fluorescence analysis, energy-dispersive X-ray spectroscopy and for example wavelength-dispersive X-ray spectroscopy. In principle, however, any method which is familiar to a person skilled in the art and is suitable for the present purpose or a combination of a plurality of such methods can also be used in this case.

The method can include an eddy-current method. The eddy-current method is an electrical method for non-destructive material testing which can be used to inspect electrically conductive materials, for example metal powders. In this case, eddy currents can be induced in the modelling material by alternating magnetic fields. During the measurement, the eddy-current density can be detected, by a sensor, by the magnetic field generated by the eddy currents. In this case, use is made of the fact that impurities in an electrically conductive material have a different electrical conductivity or a different permeability than the material itself.

According to one development, the modelling material can be supplied in the form of powder.

According to one development, the modelling material can be selected from the group comprising metal materials, metal material combinations and metal alloys.

According to one development, the modelling material can be selected from the group comprising aluminum, titanium, nickel or an alloy thereof.

According to one development, the quality characteristics can be selected from the group comprising a degree of purity, a degree of moistness, a degree of contamination with foreign bodies and a degree of contamination with substances or the like. Other quality characteristics considered comprise for example the size or particle size of a powder and the particle-size distribution or shape distribution thereof. Furthermore, the porosity, the density, thermal properties, the surface area and/or the surface structuring and/or the microstructuring of the modelling material or the like are considered as quality characteristics. These quality characteristics can affect different aspects of the printing method. For example, the deformation and flow behaviour are determined significantly by the geometric properties of the modelling material, for example the size and shape of the powder particles, which in turn can have an effect on a sufficiently consistent supply and distribution of the modelling material during depositing. Foreign bodies and impurities can affect the mechanical integrity of the printed component, whereas the porosity can determine the sintering or melting properties and ultimately the future density of the component. For example, a pulverulent modelling material can be permeated by moisture, water, oils, fats, etc. However, low traces of these impurities can be insignificant depending on the application, and therefore the printing process can be terminated only after the degree of contamination has exceeded a preset threshold. Depending on the quality characteristic, a person skilled in the art will select a corresponding method for determination. Based on the determined quality characteristics, in particular the uniformity of material batches (for example of a powder) can be determined and analyzed, and so deviations and fluctuations between the different batches can be defined and assessed.

The configurations and developments above can be combined with one another as desired where appropriate. Further possible configurations, developments and implementations of the disclosure herein also do not comprise explicitly mentioned combinations of features of the disclosure herein described previously or in the following with respect to the embodiments. In particular in this case, a person skilled in the art will also add individual aspects as improvements or supplements to the respective basic form of the present disclosure.

### BRIEF DESCRIPTION OF THE DRAWINGS

The present disclosure will be described in greater detail below on the basis of the embodiments shown in the schematic drawings, in which:

FIG. 1 is a schematic view of a 3D-printing device for carrying out a 3D-printing method according to one embodiment of the disclosure herein; and

FIG. 2 is a schematic flow chart of the 3D-printing method which is carried out by the 3D-printing device from FIG. 1.

The accompanying drawings are intended to provide further understanding of the embodiments of the disclosure herein. They illustrate embodiments and are used, in conjunction with the description, to explain principles and concepts of the disclosure herein. Other embodiments and many of the above-mentioned advantages can be found from the drawings. The elements of the drawings are not necessarily shown to scale with respect to one another.

In the figures of the drawings, elements, features and components which are like, functionally like or have the same effect—unless otherwise specified—are each provided with the same reference numerals.

### DETAILED DESCRIPTION

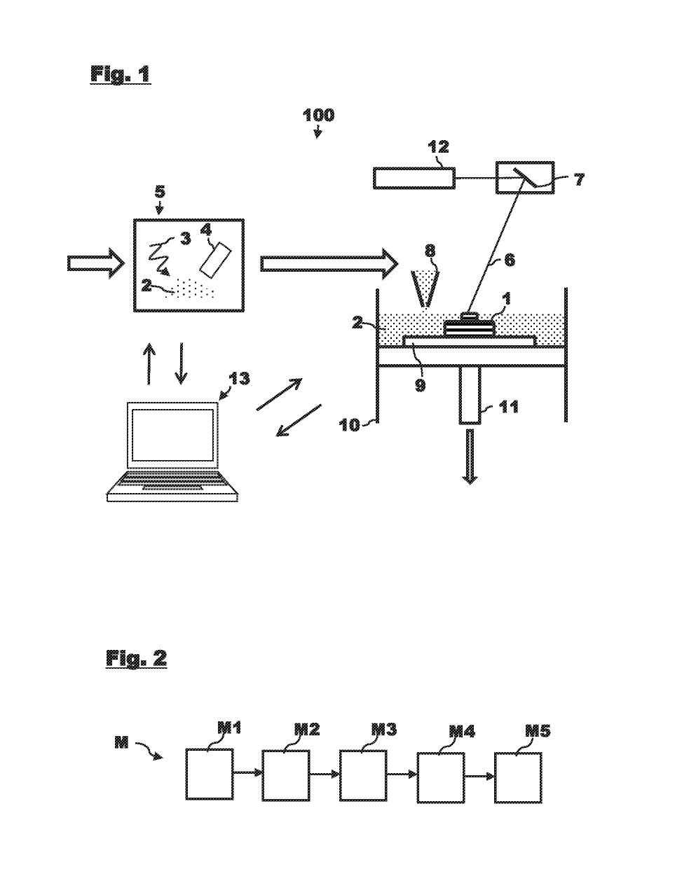

FIG. 1 is a schematic view of a 3D-printing device 100 for carrying out a 3D-printing method M according to one embodiment of the disclosure herein. FIG. 2 is a schematic flow chart of a 3D-printing method M of this type.

The 3D-printing method is used for the additive production of components 1. For this purpose, the 3D-printing method M includes, in M1, supplying a modelling material 2 to a 3D-printing device 100. Furthermore, in M2, the 3D-printing method M further comprises determining quality characteristics of the modelling material 2 using a monitoring device 5 and, in M3, analyzing a product quality of the modelling material 2, using an analysis device 13, on the basis of determined quality characteristics. In addition, in M4, the 3D-printing method M comprises depositing and liquefying M4 the modelling material 2 layer by layer, and in M5, curing M5 the liquefied modelling material 2 layer by layer.

In this case, the modelling material 2 can be a plastics material or for example selected from the group comprising metal materials, metal material combinations and metal alloys. In particular, the modelling material 2 can be for example titanium, aluminum, nickel, steel and/or an alloy or material combination thereof. For example, the modelling material 2 can be an aluminum/silicon powder, for example AlSi10Mg, or a more advanced material or a material mixture such as Scalmalloy® or the like. Furthermore, the modelling material 2 can be supplied and deposited in the form of a powder.

In principle, the present disclosure provides various possibilities for liquefying the modelling material 2, in which heat can be locally introduced in a targeted manner into deposited modelling material 2. In particular, the use of lasers and/or particle beams, for example electron beams, is advantageous, since in this case, heat can be generated in a very targeted and controlled manner. The 3D-printing method M can thus be selected for example from the group comprising selective laser sintering, selective laser melting, selective electron-beam sintering and selective electron-beam melting or the like. However, in principle, any desired additive method can be used. In the following, the 3D-printing method M is described by way of example in connection with selective laser melting (SLM), in which the modelling material 2 is applied in powder form to a work platform 9 and is liquefied in a targeted manner by local laser radiation by a laser beam 6, resulting in a solid, continuous component 1 after cooling.

The 3D-printing method M is carried out by the 3D-printing device 100 in FIG. 1. An energy source in the form of a laser 12, for example a Nd:YAG laser, transmits a laser beam 6 selectively onto a specific part of a powder surface of the pulverulent modelling material 2, which rests on a work platform 9 in an operating chamber 10. For this purpose, an optical deflecting-device or a scanner module such as a movable or tiltable mirror 7 can be provided, which deflects the laser beam 6 according to the tilt position thereof onto a specific part of the powder surface of the modelling material 2. At the point of incidence of the laser beam 6, the modelling material 2 is heated, and so the powder particles are locally melted and form an agglomerate upon cooling. The laser beam 6 scans the powder surface on the basis of a digital production model which is for example provided and optionally processed by a CAD (computer-aided design) system. After the selective melting and local agglomeration of the powder particles in the surface layer of the modelling material 2, excess modelling material 2 which is not agglomerated can be discarded. The work platform 9 is then lowered by a lowering piston 11 (see arrow in FIG. 1), and by a powder supply 8 or another suitable device, new modelling material 2 is transferred from a reservoir into the operating chamber 10. In order to accelerate the melting process, the modelling material 2 can be preheated by infrared light to a working temperature which is just below the melting temperature of the modelling material 2. In this way, in an iterative generative construction method, a three-dimensional sintered or “printed” component” 1 is produced from agglomerated modelling material 2. In this case, the surrounding pulverulent modelling material 2 can be used to support the part of the metal component 1 that has been constructed up to that point. By the continuous downwards movement of the work platform 9, the component 1 is formed in a layer-by-layer model generation.

The 3D-printing method M is characterised in that modelling material 2 is examined and analyzed during the supply into the powder supply 8 before the depositing. In this case, all or a portion of the modelling material 2 is conducted through a monitoring device 5 (see arrows in FIG. 1), in which specific quality characteristics of the modelling material 2 are determined. For example, a specific fraction of the modelling material 2 can be continuously branched off, and the quality thereof can be evaluated. A quality characteristic of this type can be for example a degree of purity, a degree of moistness, a degree of contamination with foreign bodies or with other substances, or another representative and measurable variable which provides information about the grade or quality of the modelling material 2. Other quality characteristics which are considered include for example the particle size of the powder. For example, a pulverulent modelling material can be loaded with moisture, water, oils, fats, etc., wherein the severity of the impurity can accordingly be indicated quantitatively by a suitable method. Provided methods include spectrometric methods, gas-sensor methods, optical methods, electrical methods and other methods which are familiar to a person skilled in the art. The method can be selected for example from the group comprising X-ray spectrometric methods, electron-spectrometric methods and infrared-spectrometric methods or the like. Possible X-ray spectrometric methods are in particular X-ray absorption spectroscopy, X-ray emission spectroscopy, photoemission spectroscopy, X-ray fluorescence analysis, energy-dispersive X-ray spectroscopy and for example wavelength-dispersive X-ray spectroscopy. To represent this, FIG. 1 shows analytical radiation 3, which is directed onto the modelling material 2 (in this case a powder), a corresponding detector 4 detecting radiation emanating from the irradiated powder. However, optical methods, electrical eddy-current methods or gas-sensor methods using a chemical sensor or an electronic nose can also be used. Non-destructive methods in which all of the modelling material 2 is also still available for the subsequent printing method can be particularly advantageous.

On the basis of the quality characteristics 3 determined in such a way, the product quality of the modelling material 2 is analyzed by the analysis device 13. By communication between the monitoring device 5 and the analysis device 13 (see arrows in FIG. 1), it is possible to analyze the components of the supplied modelling material 2—and if present—undesirable chemical elements, and to detect other foreign substances or foreign particles or material residues. Forming an evaluation result can include for example multivariate, that is to say multidimensional, analysis methods, for example of the measured radiation spectrum based on a chemometric method. Known mathematical or statistical tools from the field of multivariate data analysis can thus be used, and so even small impurities can be made quick to detect. A person skilled in the art will be able to accordingly choose between various analysis methods in order to find a compromise between precision and complexity, that is to say ultimately the duration, of the analysis, which compromise is suitable for each application. In developments of the 3D-printing device 100, different analysis methods and different determination methods can be implemented, for example the methods can be stored in the storage, it being possible for the user to choose from various options. The analysis device 13 can now pause or stop the printing method completely automatically or semi-automatically or by a manual input by a communication and provide the operator with feedback about the product quality. After the evaluation of the analysis result, the 3D-printing device can be cleaned of impurities. Alternatively or additionally, the portion of the modelling material 2 having insufficient product quality can be purified and/or otherwise processed. Subsequently, it is possible to continue the printing. In particular, the modelling material 2 which is purified in such a way can continue to be used.

The present disclosure thus implements online quality monitoring of the supplied modelling material 2, which makes it possible to still examine the used modelling material 2 during the actual printing method and, on the basis of the result, optionally to stop the printing and carry out an exchange and/or processing of the material. In addition, for example by online checking of this type, the uniformity of material batches can be determined and analyzed, as a result of which the problem of differing batches can ultimately be better defined and assessed.

The described method can generally be used in all sectors of the transport industry, for example for motorised road vehicles, for rail vehicles or for watercraft, but also in the civil engineering and mechanical engineering industry.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

In the detailed description above, various features for improving the stringency of the representation have been summarized in one or more examples. However, it should be clear in this case that the above description is of a purely illustrative, but in no way limiting nature. The description is used to cover all alternatives, modifications and equivalents of the various features and embodiments. Many other examples are immediately clear to a person skilled in the art on account of their expert knowledge in view of the above description.

The embodiments have been selected and described in order to be able to show, as well as possible, the principles on which the disclosure herein is based and the possible applications thereof in practice. Consequently, people skilled in the art can optimally modify and use the disclosure herein and the various embodiments thereof with respect to intended use. In the claims and the description, the terms “containing” and “comprising” are used as neutral linguistic terminology for the corresponding term “including”. Furthermore, use of the terms “a” and “an” is not intended to fundamentally exclude a plurality of features and components described in this way.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A 3D-printing method for additive production of components, the method comprising:
supplying a modelling material to a 3D-printing device;
determining quality characteristics of the modelling material using a monitoring device;
analyzing a product quality of the modelling material, using an analysis device, on a basis of determined quality characteristics;
depositing and liquefying the modelling material layer by layer; and
curing the liquefied modelling material layer by layer.

2. The 3D-printing method of claim 1, wherein determining quality characteristics of the modelling material and analyzing product quality of the modelling material are carried out during the supply.

3. The 3D-printing method of claim 1, wherein the modelling material is supplied continuously.

4. The 3D-printing method of claim 1, wherein the quality characteristics of the modelling material are determined for only a portion of the supplied modelling material by random sampling.

5. The 3D-printing method of claim 1, wherein the layer-by-layer depositing and liquefying are stopped when the analyzed product quality does not satisfy preset quality conditions.

6. The 3D-printing method of claim 1, wherein the modelling material is purified when the analyzed product quality does not satisfy preset quality conditions.

7. The 3D-printing method of claim 1, wherein determining the quality characteristics includes a method from the group consisting of spectrometric methods, gas-sensor methods, optical methods and electrical methods.

8. The 3D-printing method of claim 7, wherein the method is selected from the group consisting of X-ray spectrometric methods, electron-spectrometric methods and infrared-spectrometric methods.

9. The 3D-printing method of claim 7, wherein the method comprises an eddy current method.

10. The 3D-printing method of claim 1, wherein the modelling material is supplied in a form of powder.

11. The 3D-printing method of claim 1, wherein the modelling material is selected from the group consisting of metal materials, metal material combinations and metal alloys.

12. The 3D-printing method of claim 11, wherein the modelling material is selected from the group consisting of aluminum, titanium, nickel and alloys thereof.

13. The 3D-printing method of claim 1, wherein the quality characteristics are selected from the group consisting of a degree of purity, a degree of moistness, a degree of contamination with foreign bodies and a degree of contamination with substances.

14. A 3D-printing device for the additive production of components using a method comprising:
supplying a modelling material to a 3D-printing device;
determining quality characteristics of the modelling material using a monitoring device;
analyzing a product quality of the modelling material, using an analysis device, on a basis of determined quality characteristics;
depositing and liquefying the modelling material layer by layer;
and curing the liquefied modelling material layer by layer;
wherein the device comprises:
a monitoring device which is configured to determine the quality characteristics of the modelling material; and
an analysis device which is configured to analyze the product quality of the modelling material on the basis of the determined quality characteristics.
